(19) United States
(12) Patent Application Publication
(10) Pub. No.: US 2020/0060241 A1
(43) Pub. Date: Feb. 27, 2020

(54) Quarantine Apparatus including Bird Health Maintenance System and a Lighting Device

(71) Applicants: David Kelly Austreng, Vancouver, WA (US); Milena Sukovic, Lincolnshire, IL (US)

(72) Inventors: David Kelly Austreng, Vancouver, WA (US); Milena Sukovic, Lincolnshire, IL (US)

(21) Appl. No.: 16/112,816

(22) Filed: Aug. 27, 2018

(51) Int. Cl. A01K 31/06; F21V 21/096; F21S 9/02; F21V 3/10; F21S 8/04; A01K 45/00

(52) U.S. Cl. CPC A01K 31/06; F21V 21/096; F21S 9/02; F21Y 2115/10; F21S 8/04; A01K 45/00; F21V 3/10

(57) ABSTRACT

A quarantine apparatus including walls, an opening for entering and exiting the apparatus, a floor made of non-porous material covered with sheeting, the sheeting covering the edges between the floor and the walls, an air decontamination device to take in air and filter out contaminants, the air decontamination device attached to the apparatus, a ceiling of the apparatus joined together with the walls, the ceiling including diffusion material having a diffusion structure, a bird health maintenance lighting system secured above the ceiling, secured to direct light into the apparatus, and the bird health maintenance lighting system including at least one luminous element.

### FIELD OF DISCLOSURE

The present disclosure relates generally to a quarantine apparatus including a bird health maintenance system and a lighting device.

### BACKGROUND

A pet bird supplier ships a bird to a customer after having received the bird from a multitude of different breeding sources. Alternatively, the bird supplier may have the bird shipped to the customer directly from the source. Each source should have procedures for ensuring a bird it ships has reduced risk of it being shipped with a disease. Conventional procedures used to reduce risk of shipping a diseased bird employ a quarantine procedure. The quarantine procedure isolates the bird in a containment area for a specified period of time. Holding the bird in the isolated containment area for a specific period of time allows the bird to be monitored and observed for symptoms of a disease. If, after the bird was isolated in the containment area for the quarantine time without showing any symptoms of disease, the bird was examined by a veterinarian to be disease free, and the bird was provided a certificate of veterinary inspection, then the bird could be shipped to a customer.

There is a problem with holding the bird in a conventional quarantine containment area for a quarantine time. The problem is the bird is typically isolated in the area with no natural light. This causes some birds to lose their health and vigor.

There is a need for an improved quarantine apparatus with a bird health maintenance system and lighting device.

There is also a problem in the industry in that bird sources do not have an understanding of the minimum requirements for a quarantine containment area. There is a need to provide an improved quarantine apparatus with a bird health maintenance system and lighting device to set a minimum standard for reducing the possibility of shipping a diseased bird.

There is also a need to provide a bird health maintenance system or lighting device to anyone handling or keeping a bird to for example help reduce loss of the bird's health and vigor or maintain a suitable environment.

### SUMMARY

A quarantine apparatus including walls, an opening for entering and exiting the apparatus, a floor made of non-porous material covered with sheeting, the sheeting covering the edges between the floor and the walls, an air decontamination device to take in air and filter out contaminants, the air decontamination device attached to the apparatus, a ceiling of the apparatus joined together with the walls, the ceiling including diffusion material having a diffusion structure, a bird health maintenance lighting system secured above the ceiling, secured to direct light into the apparatus, and the bird health maintenance lighting system including at least one luminous element.

A bird health maintenance system, the system including a bird health lighting device, an attachment device for securing the bird health lighting device over a quarantine apparatus, the bird health lighting device including a luminous element directing light toward the quarantine apparatus, and a diffusion material positioned between the apparatus and the bird health lighting device.

A bird health lighting device including a base holding at least one luminous element, an attachment device to attach the base to a bird cage, a power source configured to source the luminous element, and panels extending from the base, attaching the base to a diffusion structure.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of some of those embodiments.

The apparatus and method components have been represented where appropriate by conventional symbols in the drawings, showing only those specific details that are pertinent to understanding the embodiments of the disclosure herein so as not to obscure the disclosure with details that will be readily apparent to those of ordinary skill in the art having the benefit of the description herein.

FIG. 1 illustrates a perspective view of an embodiment of a quarantine apparatus.

FIG. 2a illustrates a perspective view of an embodiment of a quarantine apparatus including a transparent top-down view of an embodiment of a bird health maintenance system.

FIG. 2b illustrates a top-down view of the embodiment illustrated in FIG. 2a.

FIG. 3 illustrates a cross-sectional view embodiments of a diffusion structure of the example bird health maintenance system of FIG. 2.

FIG. 4 illustrates a perspective view of an embodiment of a diffusion material 400.

FIG. 5 illustrates an embodiment of a bird health lighting device.

### DETAILED DESCRIPTION

As stated above, there is a need for an improved quarantine apparatus including a bird health maintenance system and a bird health lighting device.

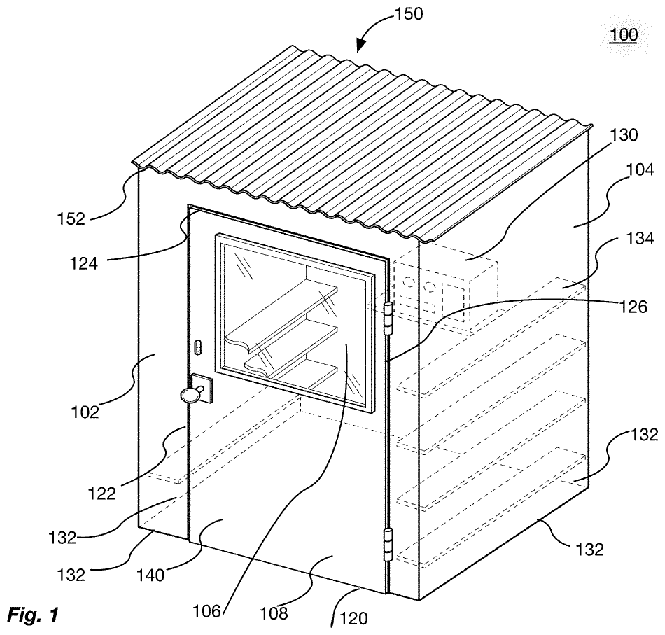

FIG. 1 illustrates an embodiment of a quarantine apparatus 100. A quarantine apparatus 100 can be used to store a bird to verify whether the bird is free of contaminants. Maintaining health of the bird during its time in the quarantine apparatus is of interest. In an embodiment, the quarantine apparatus 100 includes a plurality of walls, for example a front wall 102, a right-side wall 104, a left side wall (not visible from perspective), and a back wall (not visible from perspective), all joined together and sealed respectively with non-permeable sealant (e.g., silicone sealant). Each of the walls can be lined with non-porous plastic sheeting 106 (shown as covering the back wall, as viewed through glass of the door opening). In an embodiment, the sheeting 106 is made of polystylene plastic sheeting. In an embodiment, the sheeting 106 is made of Visqueen™ brand plastic sheeting material.

FIG. 1 illustrates an embodiment of a quarantine apparatus opening 108 for entering and exiting the apparatus 100. In this embodiment, the opening 108 is a door. The opening 108 has edges 120, 122, 124, 126. Each of the opening edges 120, 122, 124, 126 can be covered with the non-permeable sealant. Each of the opening edges 120, 122, 124, 126 can have a corresponding quarantine apparatus edge to come in contact with it to form a quarantine grade seal.

In an embodiment, each opening edge 120, 122, 124, 126 can have a tapered addition (not shown, but understood by one of ordinary skill in the art of sealed door construction) attached to its edge to form a better seal with the corresponding quarantine apparatus edge. In an embodiment, each corresponding quarantine apparatus edge can also have a tapered addition attached to its edge to form a more solid seal with the tapered addition of the corresponding opening edge.

In an embodiment, an air decontamination device 130 is housed inside the quarantine apparatus 100. The quarantine device can include shelves 134 for holding bird cages (not shown) or the bird cages can be affixed to the apparatus 100. In an embodiment, the air decontamination device 130 takes in air and filters out contaminants from the air to recirculate the filtered air inside the quarantine apparatus 100. In another embodiment, the air decontamination device 130 takes air in from outside the quarantine apparatus 100 and filters it before directing it into the quarantine apparatus 100. In another embodiment, the air decontamination device 130 takes air from inside the quarantine apparatus 100 and filters it before directing it out of the quarantine apparatus 100. The air can be directed into or out of the quarantine apparatus 100 with any kind of air decontamination device 130 and ventilation conduit known in the art at the time of filing.

In use, air will come into the quarantine apparatus 100 when a person opens the door to handle a bird designated for a quarantine procedure. For example, a person can open the quarantine apparatus during specified times a day to take care of the bird. For example, an opening of the apparatus 100 may include any combination of a first opening 108 and of a second backup opening (not shown) made of, for example, vertically extended flexible plastic sheets extending at least the length of the opening 108 and each of the vertically extended flexible plastic sheets overlapping with its next placed sheet until each respective end sheet overlaps its respective left or right side of the wall. The second opening can be used to add another layer of a cross contamination barrier (besides the first opening 108) to reduce air particle movement from moving into or out of the quarantine apparatus.

In an embodiment, the opening 108 can be left in an open position while a bird handler performs any of: feeding, watering, or cleaning up after the bird. A bird handler may perform a maintenance procedure, which can take about 15 minutes. If the opening 108 remains open, then the backup opening would maintain a closure status of the quarantine apparatus 100 to protect from possible contaminants exiting the apparatus 100 during the time of bird handling or quarantine.

In an embodiment, the quarantine apparatus 100 includes a floor 140. In an embodiment, the floor 140 is made of non-porous material, which can be wood covered with paint sealant. In an embodiment, the floor 140 is made of MDF wood. MDF is an engineered wood composite that is similar to particle board, but is much denser and stronger than particle board as it is mixed with binding ingredients. Each edge e.g., 132 of the floor 140 can be sealed to a wall e.g., 102 or an opening 108 with a non-permeable sealant or a tapered attachment or both. In an embodiment, the floor 140 is made of non-porous material covered with sealant, and covered with sealant at the edges between the floor 140 and the walls 102, 104, etc. In an embodiment, one or more edges inside the apparatus 100 is covered with non-permeable sealant and non-porous plastic sheeting. In an embodiment, one or more edges inside the apparatus 100 is covered with non-permeable sealant or non-porous plastic sheeting. In an embodiment, each edge inside the apparatus 100 is covered with non-permeable sealant or non-porous plastic sheeting or both.

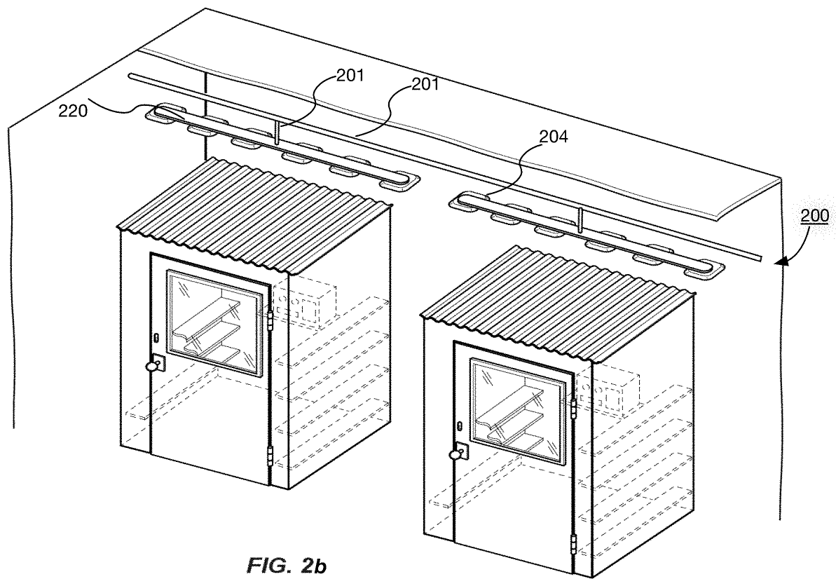

FIG. 1 illustrates an embodiment of the quarantine apparatus 100 having a ceiling 150. In an embodiment, the ceiling 150 can have at least some portion of it including a diffusion material 152 with a light diffusion structure. In an embodiment, a diffusion material is a translucent or transparent material. In the embodiment of FIG. 1, a largest possible portion can be the entire the ceiling 150. In the embodiment, the entire ceiling 150 is made of a diffusion material 152. In other embodiments, a portion of the ceiling 150 can consist of the diffusion material 152 while the remainder of the ceiling can consist of one or more other materials. The ceiling 150 of the quarantine apparatus 100 is sealed to each of the walls with a non-permeable sealant. In an embodiment, the diffusion material 152 includes or consists of a polycarbonate material having a light diffusion structure (See FIG. 3 for example embodiment of a light diffusion structure 300).

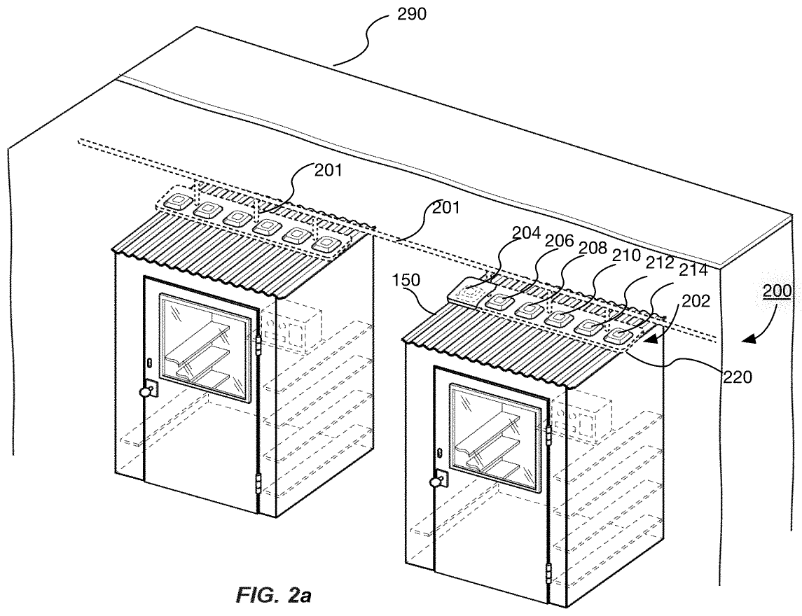

FIG. 2a illustrates a perspective view of an embodiment of a quarantine apparatus including a transparent top-down view of an embodiment of a bird health maintenance system. A plurality of the quarantine apparatus 100, 100 can be housed in a warehouse 290. An embodiment of a bird health maintenance system 200 is illustrated with an external bird health lighting device 202. The term “external” is used to distinguish whether an embodiment of a lighting device is external or internal relative to a holding unit where the bird is held. For example, in FIG. 1 the quarantine apparatus 100 serves as a holding unit for the bird. The lighting device 202 is external to the holding unit. The lighting device 202 is external and positioned over the ceiling 150 of the apparatus 100, which is the holding unit.

An embodiment of a bird health lighting device 202 can be secured over a quarantine apparatus 100 with an attachment device 201. The attachment device 201 attaches the lighting device 202 to a warehouse 290 holding the one or more quarantine apparatus e.g., 100, 100. Alternatively, an attachment device 201 can secure a bird health lighting device 202 to the ceiling 150 of the quarantine apparatus 100. Alternatively, an attachment device 201 can secure a bird health lighting device 202 to both the quarantine device 100 and a warehouse 290 so that the bird health lighting device 202 directs light into the apparatus 100.

In an embodiment, the bird health lighting device 202 includes an embodiment of a luminous element 204. In an embodiment, the bird health lighting device 202 includes any plurality of luminous elements 204, 206, 208, 210, 212, 214, etc., for example, limited in number by their respective surface area and the surface area available to secure the plurality or any lesser number of luminous elements. In an embodiment, the luminous element is manufactured by Ecogrow™.

FIG. 2a illustrates a perspective view of a bird health maintenance system 200 including a bird health lighting device 202 and a ceiling 150 of a quarantine apparatus 100 having at least a portion of the ceiling 150 include a diffusion material 152. An embodiment of the bird health lighting device 202 includes a base 220 supporting at least one luminous element 204. In an embodiment, one or more luminous elements 204, 206, 208, 210, 212, 214, etc. can be secured to the base 220. FIG. 2b illustrates a top-down view of the embodiment illustrated in FIG. 2a. FIG. 2b illustrates an alternative base 220 structure.

The base 220 can include circuitry to supply electricity to each luminous element e.g., 204. Alternatively, each luminous element can be self-powered, for example, by a battery. The base 220 can include one or more magnets which come into contact with and correspond to a magnet of each luminous element e.g., 204. In an embodiment, the base 220 is coupled to the warehouse 290 with an embodiment of attachment device 201.

Each luminous element e.g., 204 includes a light source (not shown). The light source can be, for example, a light emission diode (LED). In an embodiment, the light source can emit light of a particular frequency range. For example, the frequency range can be in the ultraviolet range, such as in or about 10 nm to 400 nm. The light source can provide light in or about the ultraviolet frequency range of 365 nm to 395 nm. LEDs can be used near birds because they do not heat up like an incandescent light source. In another embodiment, the light source can be a compact fluorescent light bulb (CFL).

FIG. 3 illustrates a cross-sectional view of embodiments 302, 304, 306 of a diffusion structure 300 of the example bird health maintenance system 200 of FIG. 2. A diffusion material 152 can consist of or include an embodiment of a light diffusion structure 300. In an embodiment, physical characteristics of the light diffusion structure 300 can include a greater surface area at the distal surface 320 from a light source than a surface area of the proximate surface 322. Example diffusion structure 302 illustrates a shape of the proximal surface 322 which is different from a shape of the distal surface 320. For example, the shape of the proximal surface 322 is planar and the shape of the distal surface 320 includes a plurality of concavities 310 and convexities 312. For example, each of the respective surface areas can be distal or proximate to at least one luminous element 204. In another embodiment, diffusion structure 304 includes a proximal surface 342 having a surface area the same or similar to the surface area of the distal surface 340. Example diffusion structure 304 illustrates a shape of the proximal surface 342 which is in planar alignment with a shape of the distal surface 340. In another embodiment, diffusion structure 306 includes a proximal surface 362 having a surface area the same or similar to the surface area of the distal surface 360. Example diffusion structure 306 illustrates a shape of the proximal surface 362 which is in reverse planar alignment with a shape of the distal surface 360. In an embodiment, physical characteristics of the light diffusion structure 300 can include one or more light dispersion structures. In an embodiment, physical characteristics of the light diffusion structure 300 can include one or more light diffraction structures.

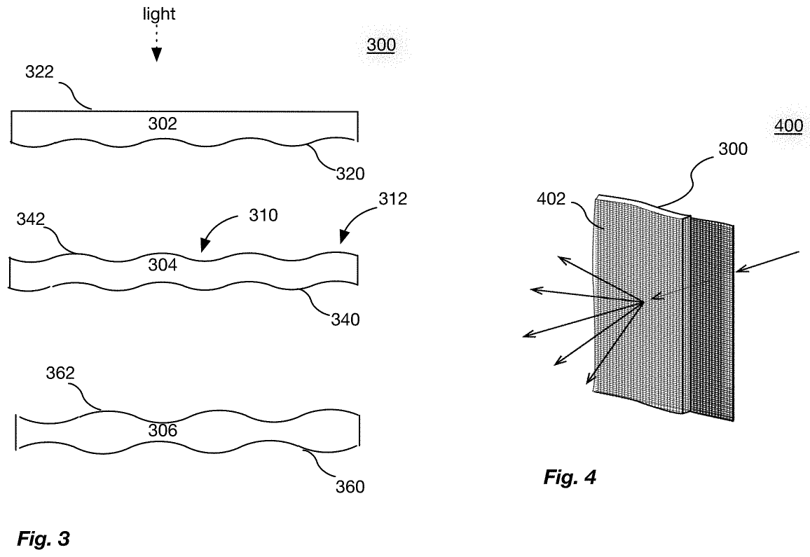

FIG. 4 illustrates a perspective view of an embodiment of a diffusion material 400. FIG. 1 illustrated an embodiment of diffusion material 152. Diffusion material 152 can consist of or include embodiment of diffusion material 400. Diffusion material 400 includes a diffusion structure 300 and an embodiment of a diffusion film 402. An embodiment of a diffusion film 402 includes a scrim panel with a fabric diffusion cloth covering it. In an embodiment, the fabric diffusion cloth is a fine wire mesh or a translucent gauze type material. In an embodiment, a luminous element 204 can have an embodiment of a diffusion film 402 covering its light source housing.

Embodiments of a light diffusion material 400 can cause light to be scattered or diffused toward the bird inside the quarantine apparatus 100. Birds can benefit from more diffused artificial light which simulates daylight while housed in a quarantine apparatus 100. For example, simulation of natural light can help birds improve their immune system, reduce fatigue, or minimize stress levels. Light exposure can affect a bird's metabolic processes as well as trigger certain behavioral and physical changes including sleeping, migrating, molting, or breeding.

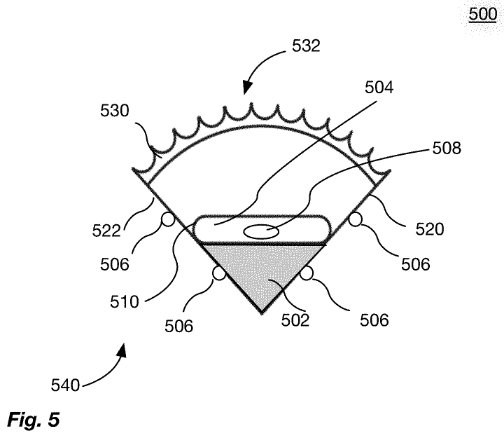

FIG. 5 illustrates an embodiment of a bird health lighting device 500. Embodiments of bird health lighting device 500 can provide the same or similar benefits as described above. FIG. 2a illustrated an embodiment of a bird health maintenance system 200 with an “external” bird health lighting device 202, which was “external” relative to a holding unit where the bird is held. Bird health lighting device 500 is an example of an “internal” bird health lighting device where the device 500 is placed “internal” relative to the holding unit where the bird is held. Embodiments of bird health lighting device 500 can be placed inside or internal to a cage, which can be the holding unit in which the bird is cared.

An embodiment of a bird health lighting device 500 includes a power source and a base 502 holding at least one luminous element 504, which can be magnetically attached to the base. In an alternative embodiment the luminous element 504 can be attached by any conventional attachment device. An embodiment of a bird health lighting device 500 includes one or more attachment devices 506 to attach the base 502 to the bird housing unit, for example a cage (not shown). In an embodiment, the luminous element 504 includes a light source 508 and a light source housing 510. In an embodiment, the luminous element 504 can include an embodiment of a diffusion film (not shown).

Each luminous element 504 can include an individual battery source or can be electrically sourced via a battery and circuit connecting to each luminous element 504, from the base 502, or can be electrically sourced via a power chord attachment (not shown) running through the base 502. Base 502 can have attached panels or flat or curved components 520, 522 extending vertically along the bird cage to which it is designed to be secured. The panels or components extend from the base to attach the base to a diffusion structure 530. The components can be of a shape matching the shape of a component of a particular conventional bird cage.

An embodiment of a bird health lighting device 500 includes an embodiment of a diffusion structure 530. An embodiment of diffusion structure 530 can consist of or include any combination of elements of the above described diffusion structures 300, 400. An embodiment of diffusion structure 530 can consist of or include a curved form 532 of any combination of elements of the above described diffusion structures 300, 400. An embodiment of a bird health lighting device 500 includes a triangular base structure 540. The triangular structure 540 provides for efficient space placement in any one or more corners of a bird cage having a corner. In an alternative embodiment, the base 502 can have a curved structure to better come into more surface area contact with a curved cylindrical shaped conventional birdcage.

An embodiment, diffusion structure 530 can include a combination of joined sharp sided concave shaped portions, as depicted in FIG. 5. In an embodiment, diffusion structure 530 can include a combination of joined sharp sided convex shaped portions (not shown). In an embodiment, diffusion structure 530 can be smooth and curved extending from a first panel to a second panel. In an alternative embodiment, diffusion structure 530 can include a diffusion film layered over any particular structure it can have. In an embodiment, diffusion structure 300 or 400 can include a combination of joined sharp-sided concave or convex shaped portions. In an embodiment, diffusion structure 300 or 400 can include a combination of joined sharp-sided concave or convex shaped portions extending linearly across the surface. In an embodiment, diffusion structure 300 or 400 can include a combination of joined alternating sharp-sided concave and convex shaped portions extending linearly across the surface, as depicted in the ceiling 150 illustrated in FIG. 1.

Claimed is:

1. A quarantine apparatus to store a bird to verify the bird is free of disease, while maintaining health of the bird during its time in the quarantine apparatus, the apparatus comprising:
a plurality of walls joined together, the walls lined with non-porous plastic sheeting;
the edges between the walls covered with non-porous plastic sheeting;
an opening for entering and exiting the apparatus, the opening having a plurality of edges;
the edges of the opening having a surface coming in contact with the surface of the corresponding wall edges;
the surfaces of the opening edges and the corresponding wall edges covered with the non-permeable sealant;
a floor made of non-porous material covered with the non-porous plastic sheeting, the non-porous plastic sheeting covering the edges between the floor and the walls;
an air decontamination device to take in air and filter out contaminants from the apparatus, the air decontamination device attached to a wall of the apparatus, the air decontamination device having a tube exiting out the apparatus;
a ceiling of the apparatus joined together with the walls, the edges between the ceiling and the walls covered with the non-permeable sealant, the ceiling including diffusion material having a diffusion structure;
a bird health maintenance lighting system secured above the ceiling, secured to direct light into the quarantine apparatus through the ceiling; and
the bird health maintenance lighting system including at least one luminous element.

2. A quarantine apparatus of claim 1, wherein the walls and the edges between the walls are covered with non-permeable sealant.

3. A quarantine apparatus of claim 1, wherein the floor and the edges between the floor and the walls are covered with non-permeable sealant.

4. A quarantine apparatus of claim 1, wherein the ceiling consists of the diffusion material.

5. A quarantine apparatus of claim 1, wherein the diffusion material includes a polycarbonate material.

6. A quarantine apparatus of claim 1, wherein the diffusion material consists of a polycarbonate material.

7. A bird health maintenance system, the system comprising:
a bird health lighting device;
an attachment device for securing the bird health lighting device over a quarantine apparatus;
the bird health lighting device including a luminous element directing light toward the quarantine apparatus; and
a diffusion material positioned between the apparatus and the bird health lighting device.

8. A bird health maintenance system of claim 7, wherein the bird health lighting device includes a base to secure the luminous element directing light toward the quarantine apparatus.

9. A bird health maintenance system of claim 7, wherein the bird health lighting device includes a base to secure with magnets the luminous element directing light toward the quarantine apparatus.

10. A bird health maintenance system of claim 7, wherein the bird health lighting device includes a base to secure with a magnet the luminous element directing light toward the quarantine apparatus, and the luminous element includes an LED.

11. A bird health maintenance system of claim 7, wherein the bird health lighting device includes a base to secure with a magnet the luminous element directing light toward the quarantine apparatus, and the luminous element includes an LED and is powered with an internal battery.

12. A bird health maintenance system of claim 7, wherein the diffusion material includes a diffusion structure having a greater surface area at the distal surface from a light source than a surface area of the proximate surface.

13. A bird health maintenance system of claim 7, wherein the diffusion material includes a diffusion structure having a greater surface area at the distal surface from a light source than a surface area of the proximate surface from the light source; and the diffusion structure includes a shape of the proximal surface which is different from a shape of the distal surface.

14. A bird health maintenance system of claim 7, wherein the diffusion material includes a diffusion structure having a greater surface area at the distal surface from a light source than a surface area of the proximate surface from the light source; and the diffusion structure includes a proximal surface having a surface area the same or similar to the surface area of the distal surface.

15. A bird health lighting device comprising:
a base holding at least one luminous element;
an attachment device to attach the base to a bird cage;
a power source configured to source the luminous element; and
panels extending from the base, attaching the base to a diffusion structure.

16. A bird health lighting device of claim 15, wherein the base is a triangular base structure.

17. A bird health lighting device of claim 15, wherein the base is a triangular base structure and the diffusion structure includes a combination of joined sharp sided convex shaped portions.

18. A bird health lighting device of claim 15, wherein the base is a triangular base structure and the diffusion structure includes a combination of joined sharp sided concave shaped portions.

19. A bird health lighting device of claim 15, wherein the base is a triangular base structure and the diffusion structure includes a diffusion film.

20. A bird health lighting device of claim 15, wherein the diffusion structure includes a diffusion film.
